(19) United States
(12) Patent Application Publication
(10) Pub. No.: US 2017/0161687 A1
(43) Pub. Date: Jun. 8, 2017

(54) SYSTEM FOR CONNECTING USERS AND METHOD THEREOF

(71) Applicant: ANITA MAKSIMOW, Holmdel, NJ (US)

(72) Inventor: ANITA MAKSIMOW, Holmdel, NJ (US)

(21) Appl. No.: 15/440,147

(22) Filed: Feb. 23, 2017

Related U.S. Application Data
(62) Division of application No. 14/532,000, filed on Nov. 3, 2014.
Application No. 14/532,000 is a continuation-in-part of application No. 12/254,855, filed on Oct. 21, 2008, now abandoned.

(51) Int. Cl. G06Q 10/10; G06F 17/30; G06Q 50/00

(52) U.S. Cl. CPC G06Q 10/1053; G06Q 50/01; G06F 17/30867

(57) ABSTRACT

A method of connecting users is disclosed. A method may include creating a plurality of user accounts, each of the user accounts corresponding to one of the plurality of users, and having a plurality of uploadable features including a first feature permitting the user to upload at least one advertisable characteristic to a user account, forming a user network including one or more of the plurality of user accounts in communication with one or more other user accounts, identifying each of the plurality of user accounts containing the at least one advertisable characteristic, linking each of the plurality of user accounts containing the at least one advertisable characteristic, and notifying each of the plurality of user accounts containing the at least one advertisable characteristic of the identity of the other of the plurality of user accounts containing the at least one advertisable characteristic.

### CROSS-REFERENCE TO RELATED APPLICATIONS

This application is a divisional of U.S. patent application Ser. No. 14/532,000, filed Nov. 3, 2014, entitled: “SYSTEM FOR CONNECTING USERS AND METHOD THEREOF”, inventor and applicant Anita Maksimow, which is a continuation-in-part of U.S. patent application Ser. No. 12/254,855, filed Oct. 21, 2008, entitled “Computer-Implemented Self-Advertising System and Method Thereof,” the disclosures of which are incorporated by reference herein in their entirety; and the inventor and applicant claims priority of both Ser. No. 14/532,000 and 12/254,855.

### BACKGROUND

Field of the Invention

Embodiments of the present invention are generally related to systems for connecting users. More specifically, embodiments of the present invention relate to a system of connecting users to other users for a specific purpose.

Description of the Related Art

In the course of conducting everyday affairs, people generally access their networks of contacts for referrals, information and/or advice. For example, when choosing a lawyer, one might check with friends or relatives about past experiences with certain lawyers in the area. When seeking a new employee, a potential employer will often check with colleagues to see whether they know of a suitable candidate. Similarly, when investigating new investment opportunities, an investor may consult with professional advisors as to the prospects of the target company.

In each of these and many other examples, decisions are often made easier by the advice of trusted associates and friends, but often an appropriate contact with the specific information needed to help with a problem or task cannot be found. At such times, the individual may ask his or her contacts for leads to suitable contacts in their own networks of peers or colleagues. Often, such human networking can extend out several persons or “degrees,” before a suitable contact is found.

By extending an individual's “human network” out to so many degrees, a risk increases of miscommunication between respective degrees of persons and the original requestor's needs. Nevertheless, despite these shortcomings, human networks are central to most revenue-generating activities in service-based businesses, and operate at multiple levels, including personal networks, organizational networks, and associations and interest groups.

Today, many individuals may also be regarded as existing online community members, members of organizational networks or employees of small to large companies. Such individuals largely understand the value of computer networks as tools for sharing information, but presently these individuals have only limited access to tools that can give them an edge (e.g., a competitive advantage) to make better human network connections on the Internet.

For example there are currently many social networking systems available to facilitate interaction between two or more people. Networks such as MySpace®, Facebook® and Linkedin® offer predominantly social networking systems, having contain “professional” features available. A large shortcoming of each of the known social networking systems is the inability to personalize a networking search or strategy. For example, each of the aforementioned networks allow users to connect via location, interests, careers, etc. Within such categories, for example, careers, the type of career an individual may select from is one contained in a list, optionally with additional keyword searching available (e.g., legal services). Thus, an individual looking to network using such systems are limited to pre-chosen categories and groups.

Additional web-based systems exist where persons may send out a request for very specific criteria, in hopes of receiving a response from another individual. For example, advertising web sites such as www.craigslist.com allow users to advertise anything from service needs, capabilities, goods for sale, etc. These types of systems allow for users to post information about or search for nearly any characteristic, however, it also requests a second user to search for or browse through posted listings to find such first user's posting or request.

Given today's global marketplace, it is important for service-based professionals to always be “self-advertising” to gain professional contacts for any number of needs, e.g., job searching, service requests, etc. By self-advertising, users may be able to post/seek information about any aspect of his or her professional career and be networked with others who may be involved in or have an interest in such specific or obscure topics. Thus, there is a need for an improved system for connecting users for specific purposes.

### SUMMARY

Embodiments of the present invention are generally related to systems for connecting users. More specifically, embodiments of the present invention relate to a system of connecting users to other users for a specific purpose. In one embodiment, a method of self-advertising via a social network accessible through a global computer network comprises creating a plurality of user accounts, each of the user accounts corresponding to one of the plurality of users, and having a plurality of uploadable features including a first feature permitting the user to upload at least one advertisable characteristic to a user account, forming a user network including one or more of the plurality of user accounts in communication with one or more other user accounts, identifying each of the plurality of user accounts containing the at least one advertisable characteristic, linking each of the plurality of user accounts containing the at least one advertisable characteristic, and notifying each of the plurality of user accounts containing the at least one advertisable characteristic of the identity of the other of the plurality of user accounts containing the at least one advertisable characteristic.

In another embodiment of the present invention, a computer readable medium comprising a computer program having executable code, the computer program for enabling self-advertising, the computer program comprising instructions for creating a plurality of user accounts, each of the user accounts corresponding to one of the plurality of users, and having a plurality of uploadable features including a first feature permitting the user to upload at least one advertisable characteristic to a user account, forming a user network including one or more of the plurality of user accounts in communication with one or more other user accounts, identifying each of the plurality of user accounts containing the at least one advertisable characteristic, linking each of the plurality of user accounts containing the at least one advertisable characteristic and notifying each of the plurality of user accounts containing the at least one advertisable characteristic of the identity of the other of the plurality of user accounts containing the at least one advertisable characteristic.

In yet another embodiment of the present invention, a self-advertising system accessible through a global computer network, the system comprises a database hosted on a remote server, containing data sets correlating to a plurality of user accounts, each of the user accounts corresponding to one of the plurality of users, and having a plurality of uploadable features including a first feature permitting the user to upload at least one advertisable characteristic to a user account, and a computer readable medium hosted on the remote server comprising a computer program having executable code, the computer program for enabling self-advertising, the computer program comprising instructions for forming a user network including one or more of the plurality of user accounts in communication with one or more other user accounts identifying each of the plurality of user accounts containing the at least one advertisable characteristic linking each of the plurality of user accounts containing the at least one advertisable characteristic and notifying each of the plurality of user accounts containing the at least one advertisable characteristic of the identity of the other of the plurality of user accounts containing the at least one advertisable characteristic.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention and therefore, are not to be considered limiting, for the present invention may admit to other equally effective embodiments, wherein:

FIG. 1 depicts a block diagram of a general computer system in accordance with one embodiment of the present invention;

FIG. 2 depicts a block diagram of a general network system in accordance with one embodiment of the present invention;

FIG. 3 depicts a block diagram of a computer-implemented self-advertising system in accordance with one embodiment of the present invention; and

FIG. 4 is a flow diagram illustrating a method of self-advertising in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e. meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a self-advertising system. More specifically, embodiments of the present invention relate to a computer-implemented self-advertising system and method thereof.

Systems and methods in accordance with exemplary embodiments may enable individuals to connect with other individuals for a specific purpose. In some embodiments, the systems may enable a user who wants to seek out a specific product or service he or she may not have found or advertise a product or service but does not have a website or many connections on social networking sites. A system in accordance with embodiments of the present disclosure may enable business owners to seek out clients, specific products or services, business opportunities, and/or the like. Individuals may use systems and methods in accordance with exemplary embodiments to search for employment, products or services, advertise specific products and services or network with people for a specific purpose. In some embodiments, the system may allow a user to create a searchable post that may be found by keywords associated with a second user's profile, or the like. When the searchable post is matched with keywords associated with another user's profile a match may be automatically generated by the system and/or an entire social network of relevant users may be matched and/or linked with the user who posted the searchable post, or the like.

Systems and methods in accordance with embodiments of the present disclosure may allow an individual to customize a basic profile and enter key words to describe what he or she is promoting and/or searching. The key words may be matched with searchable posts and/or key words from another user and matches between users may automatically be generated. In some embodiments, the systems and methods of the present invention may automatically link users such that creation of a user profile including keywords and/or a searchable post would automatically link the user with other users in the system based on the keyword and searchable post matches, thereby automatically forming a network of users, and/or the like.

In some embodiments, systems in accordance with embodiments of the present disclosure may automatically link profiles based on what information the individual enters. This is advantageous over other systems in that it eliminates the need to spend time researching websites, other user profiles, or classified ads for the user's specific needs. When the user enters what he or she is searching for through a searchable post, a system and method in accordance with embodiments of the present disclosure may connect the user's profile to the appropriate profiles of other users based on the searchable post. A notification may be generated by the system when the user is linked to relevant profiles. After a link is formed, a system in accordance with exemplary embodiments of the present disclosure may enable a user to ask a question to a linked user or ask for further details. In exemplary embodiments, a searchable post may be edited at any time before deletion and the user's social network of linked users may be updated in real-time or substantially in real-time.

In exemplary embodiments a system in accordance with embodiments of the present disclosure may enable a user to (1) create an account with a user name and password, providing the user with access to search, post or network once after the user signs on under a My Account section; (2) create a profile page with occupation, location, interests, or the like; and (3) either create a searchable post of what the user wants to promote or search other searchable posts for something the user needs. An alert or notification will be sent to alert the posting user of a match based on the keywords entered in the searchable post. A system in accordance with exemplary embodiments will link user accounts and/or profiles relevant to a user's post or search.

In general searchable posts may not be deleted until the user deletes the post. A system in accordance with exemplary embodiments may align information related to a user's specific purpose entered in keyword form, or the like. A system in accordance with exemplary embodiments aligns information and notifies individuals immediately if there is a similar interest between two or more users. There is no need to waste time searching information in a post form, such as within a networking group, or the like. The system allows a user to enter exactly what they need and then notify the user once another person online can offer what the user's search may be. A user can also use the system to search for what people are looking to connect with other people for.

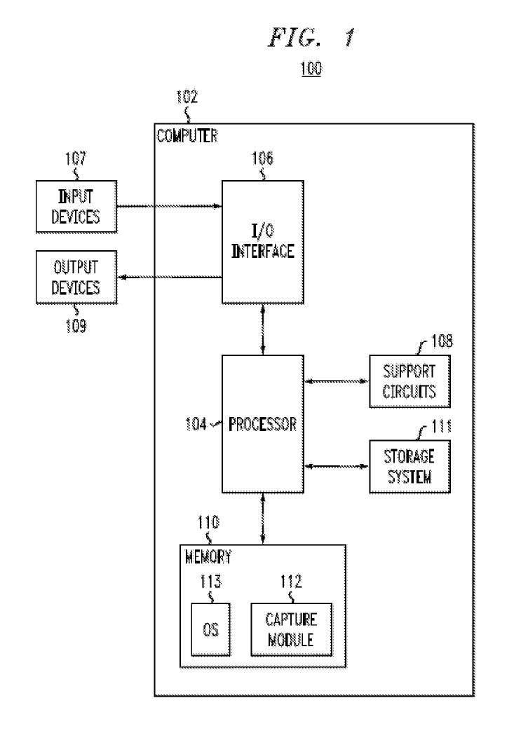

FIG. 1 depicts a block diagram of a general computer system in accordance with one embodiment of the present invention. The computer system 100 generally comprises a computer 102. The computer 102 illustratively comprises a processor 104, a memory 110, various support circuits 108, and I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

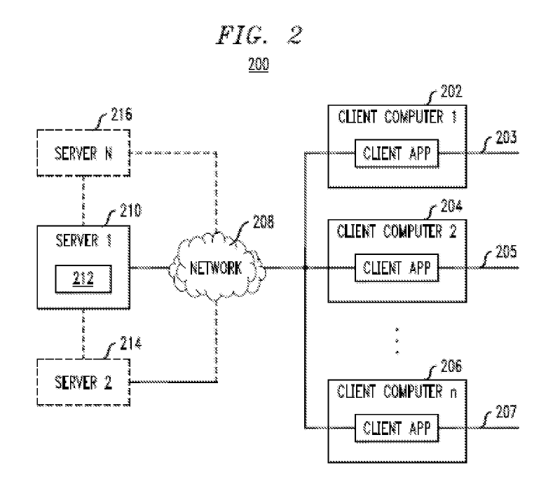

FIG. 2 depicts a block diagram of a general network system in accordance with one embodiment of the present invention. The system 200 generally comprises a first client computer 202, a second client computer 204, and additional client computers, up to N client computer 206 (hereinafter “client computer N”), where N represents any number of client computers practical for operation of embodiments of the present invention. The system 200 further includes a network 208, a server 210, a mixer 212, and optionally a plurality of N additional servers 214, 216 (hereinafter “N server”). The network 208 may be any network suitable for embodiments of the present invention, including, but not limited to, a global computer network, an internal network, local-area networks, wireless networks, and the like.

The first client computer 202 comprises a client application 203. The client application 203 is generally software or a similar computer-readable medium capable of at least enabling the first client computer 202 to connect to the proper network 208. In one embodiment, the client application 203 is software, commercially available from a software retailer. In another embodiment, the client application 203 further provides instructions for various inputs (not shown), including a mouse or a keyboard, both analog and digital, and also provides instructions for various outputs (not shown), including a speaker, a monitor or other output devices. The second client computer 204 and client computer N 206 also comprise respective client applications (205, 207).

The server 210 may be any type of server, suitable for embodiments of the present invention. In one embodiment, the server 210 is a network-based server located at some remote destination (i.e., a remote server). In other embodiments, the server 210 may be hosted by one or more of the client computers. Additional embodiments of the present invention provide the server 210 is located at an internet service provider or other provider and is capable of handling the transmission of multiple client computers at any given time.

The server 210 may also comprise a server application 212. The server application 212 may comprise software or a similar computer-readable medium capable of at least allowing client computers to connect to a proper network. In one embodiment, the server application is software, which may be available commercially from a software retailer. Optionally, the server application may comprise instructions for receiving data signals from a plurality of client computers, compiling the data signals according to unique parameters, and the like.

As is understood by one of ordinary skill in the art, multiple servers may be the most efficient methods of communication between multiple client computers when particular constraints exist. In one embodiment, multiple servers are provided to support multiple client computers in a particular session. For example, in one embodiment, a group of three client computers are connected through a first server 210 for a first session. A group of five client computers want to engage in a second session, but the first server 210 is near capacity. The group of five client computers is then connected through the second server 214 to allow for a session to take place.

For example, in another embodiment, a server 210 is provided in a system 200. As the server 210 becomes congested with multiple client computer transmissions, it may be beneficial to allow some of the client computers to pass through a second server 214, thus relieving the bandwidth on the server 210. The second server 214 and first server 210 may be connected to one another through the network and/or any other known communication means to provide the most efficient methods of communication. If necessary, additional N server 216, where N represents any number of servers practical for operation of embodiments of the present invention, may be utilized as well.

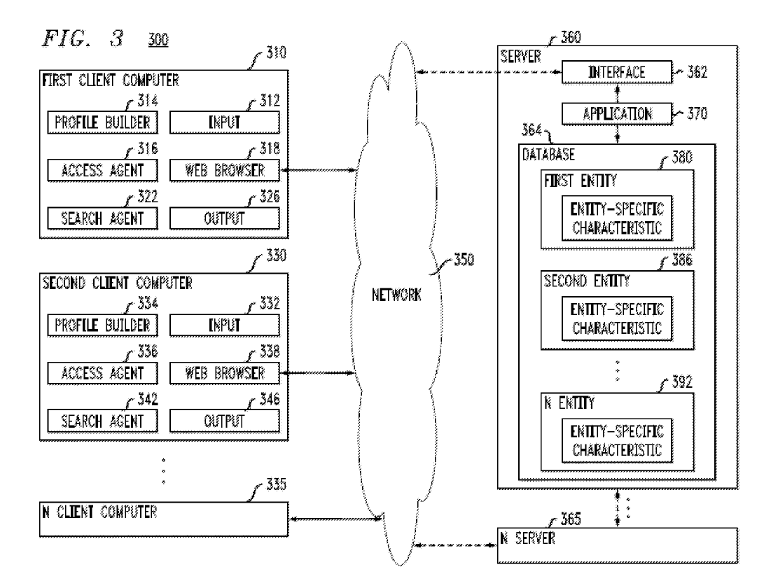

FIG. 3 depicts a block diagram of a computer-implemented self-advertising system 300 in accordance with one embodiment of the present invention. The computer-implemented self-advertising system may also be referred to generally as “a system” or “the system”.

The system 300 generally comprises a first client computer 310, a second client computer 330, a network 350, and a server 360. Optionally, a plurality of additional client computers 335 (hereinafter “N Client Computer”) and/or servers 365 (hereinafter “N Server”) may be provided, wherein N represents any number of client computers and servers practical for operation of embodiments of the present invention. The N client computers 335 and/or N Servers 365 may be utilized without deviating from the scope of embodiments of the present invention.

In one embodiment, the first client computer 310 comprises an input device 312, an output device 326, and a web browser 318 for connecting to the server 360 through the network 350. The first client computer 310 may optionally comprise any number of application tools, e.g., a profile builder 314, access agent 316, and search agent 322, which may assist with using and navigating the system 300 from the first client computer 310. Each of the profile builder 314, access agent 316 and search agent 322 may comprise software or other computer readable medium having instructions to execute a plurality of steps in accordance with embodiments of the present invention.

The input device 312 comprises at least one input device, including but not limited to a mouse, a keyboard, a touch screen, a microphone, and a data input drive, and the like. The output device 326 comprises at least one output device, including but not limited to headphones, speaker(s), a video monitor, a computer monitor, a printer, an electronic output, and the like.

The second client computer 330 similarly comprises an input device 332, an output device 346, an interface 338 for communicating with the server 360 through the network 350, a profile builder 334, access agent 336, and search agent 342, which may assist with using and navigating the system 300 from the second client computer 330. The input device 332 and output device 346 may be substantially similar to the input device 312 and output device 326 of the first client computer 310, respectively.

Generally, the network 350 may comprise any network suitable for embodiments of the present invention, including, for example, a global computer network, an internal network, local-area networks, wireless networks, and the like. The network 350 may be a partial or full deployment of most any communication or computer network or link, including any of, any multiple of, any combination of or any combination of multiples of a public or private, terrestrial wireless or satellite, and wireless networks or links. The network 350 may include, for example, network elements from the Internet, core and proprietary public networks, wireless voice and packet-data networks, such a IG, 2G, 2.5G and 3G telecommunication networks, wireless local area networks (“WLANs”), including, Bluetooth and/or IEEE 802.11 WLANs, wireless personal area networks (“WPANs”), wireless metropolitan area networks (“WMANs”) and the like; and/or communication links, such as Universal Serial Bus (USB”) links; parallel port links, Firewire links RS-232 links, RS-485 links, and the like.

The server 360 generally comprises an interface 362, a database 364, and application 370 for facilitating and/or executing many of the operations described herein within the server 360. The interface 362 is configured to communicate with the first client computer 310 and the second client computer 330 through the network 350.

The database 364 may be any data storage database suitable for embodiments of the present invention. For example, the database 364 comprises at least one or more database management systems, such as any of an Oracle, DB2, Microsoft Access, Microsoft SQL Server, Postgres, MySQL, 4^{th} Dimension, FileMaker, Alpha Five Database Management System, or the like. Contained within the database 364 is a plurality of data sets, each comprising specific data. A first data set 380 may correlate to a first entity, whereby an entity is an individual, organization, group, business, or other defined body. Within the first data set 380, a plurality of entity-specific data is provided. A second data set 386 may correlate to a second entity, and within the second data set 386, a plurality of entity-specific data may be provided. The database 364 may also include any number of subsequent data sets 392 representing N entities (hereinafter “N entity”), wherein N represents any number of entities practical for operation of embodiments of the present invention.

The entity-specific characteristics may include any characteristic, quality, need, or desire of an entity, or the like. In accordance with one embodiment of the present invention, the entity-specific characteristic is associated with an advertisable characteristic of an entity. An advertisable characteristic is a user-defined quality, or a desired-attribute, associated with the user, such that the advertisable characteristic is the primary purpose for the user accessing the network and database described herein. In accordance with another embodiment of the present invention, an entity-specific characteristic is the entity's desire to buy or sell an item or service. In another embodiment of the present invention, the entity-specific characteristic is the entity's desire to seek employment. In yet another embodiment of the present invention, the entity-specific characteristic is the entity's desire to gain information. Other similar types of characteristics may also be included in the respective data sets within the database 364.

The application 370 comprises any number of software or instruction-based packages for facilitating user interaction with the database. In one embodiment, the application 370 comprises a data portal, accessible through a web page, for allowing the user to access, update or modify information stored on the database 364. In another embodiment, the application 370 comprises software for enabling query searching within the database 370. Such query searching is generally integral with many commercially available database programs, and thus, is understood by those of ordinary skill in the art.

The application 370 may additionally facilitate interaction between the server 360 and a social networking server (not shown), which is provided to host ordinary components of a social network, e.g., profile information, chat capabilities, multimedia storage and the like. In such an embodiment, the application 370 may directly communicate with the social networking server for allowing a user to access information, utilities and other applications contained thereon, while still allowing the user to access information stored within the database 364 on server 360. In some alternate embodiments, a user may directly connect with such a social networking server, which in turn is in communication with the server 360 to provide access to information stored within the database 364.

A memory (not shown) may also be provided within the server 360, outside of the database 364. In such an embodiment, the memory may be utilized to store information and executable instructions associated with a social network, as described above. For example, in accordance with one embodiment of the present invention, the memory may store an entity profile for each user associated with the system 300. The entity profile may contain information relating to an entity-specific characteristic of a corresponding entity or user. In one embodiment, a user may be able to create at least a portion of an entity profile associated with that entity through use of a profile builder 314 located on the client 310. Whereas the basic concepts of social networks are generally known, no further description is provided.

In another embodiment of the present invention, a verification device (not shown) may be included in the system 300. The verification device may be adapted to verify the legitimacy of information or data contained in an entity profile. Such verification device may comprise applications for generating verifiable emails (i.e., emails sent to a user requiring additional steps before an account is activated), phone verifications (i.e., phone call placed to a user to verify account information), or the like.

In another embodiment, a rating system (not shown) is included in the system of self-advertising 300. In this accord, one entity is able to evaluate another entity, generally based on the interaction between the entities. In accordance with this embodiment, the rating system may be used after an interaction between entities, and may comprise an application for providing a star-rating, numerical rating, comments, or the like.

In another embodiment of the present invention, the system of self-advertising 300 may include a revenue generating system (not shown). The revenue-generating system may comprise additional application(s) or executable instructions for monitoring activity within the system and allocating a fee associated with such activity. For example, in one embodiment, the revenue generating system may monitor an interaction between a first entity 380, a second entity 386, or an N entity 392, during a use of the system of self-advertising 300, e.g., emails, attempted solicitations/contacts, etc. In another example, an access fee may be charged to at least one of the first entity 380, the second entity 386, and an N entity 392 for using the system 300. In yet another example, the revenue generating system may include a commercial advertisement banner, pop-up, or the like. In such an example, the administrator of the system 300 may charge third parties to advertise products, businesses, or the like on the system, and charge a fixed, flexible, temporal or adjustable rate for such advertisement. This type of advertising is well known in web based systems, and as such, no further description will be provided.

In some embodiments of the present invention, a value calculator (not shown) may be included in the system of self-advertising 300. In this accord, the value calculator may be adapted to calculate a weighted value based on the veracity, scope of information, number of views/hits, etc., of an entity's profile or entity-specific characteristic. The value calculator may utilize any variation of algorithm suitable for embodiments of the present invention. By utilizing a value calculator, individual entity-specific characteristics may be valued, such that when an entity queries the database 364 for matching its own entity-specific characteristic, the database may provide non-exact results based on a high value received from the value calculator.

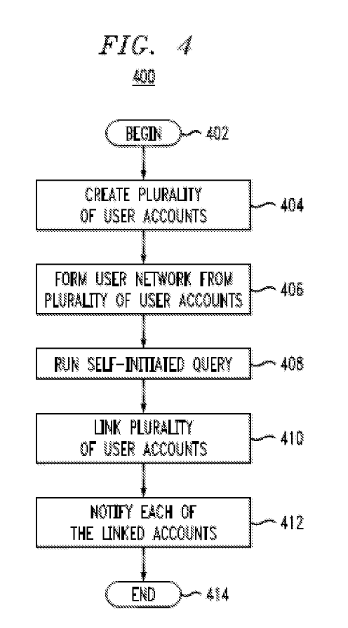

FIG. 4 is a flow diagram illustrating a method self-advertising 400, in accordance with one embodiment of the present invention. For convenience, the method of self-advertising 400 is described with reference to the computer-implemented self-advertising system 300 as shown in FIG. 3. The method of self-advertising 400, however, may be implemented using other architectures as well.

The method of self-advertising 400 begins at step 402. At step 404, a plurality of user accounts are created by a plurality of users or entities connected to the system 300. Generally, each of the user accounts corresponding to one of the plurality of entities, whereby an entity may be an individual, organization, group, business, or other defined body. Each of the user accounts comprises a plurality of uploadable features. For example, each of the user accounts may allow for uploading of entity-specific characteristics, including basic identification information, photos, videos, other multimedia, descriptions of hobbies or career interests, any advertisable characteristic, or the like.

At step 406, a user network, or social network, is formed using one or more of the plurality of user accounts in communication with one or more other user accounts. In one embodiment, as the user accounts are created, each user is associated with a data set 380, in the database 364, whereby each of the entity-specific characteristics are stored as data within the respective data sets. Creation of a user network may comprise the facilitating, through a web page, data portal or the like, the ability for one entity to access and/or view another entities' information.

At step 408, a self-initiated query is run within the database 364, to identify each of the plurality of user accounts containing at least one entity specific characteristic in common with each other. In one embodiment, the self-initiated query is enabled as soon as another entity creates a user account, uploads/modifies an entity-specific characteristic, e.g., an advertisable characteristic, or the like, within the system 300. In another embodiment, the self-initiated query identifies only those user accounts having similar or identical advertisable characteristics. In yet another embodiment, the self-initiated query identifies user accounts where one user's advertisable characteristic is listed as an attribute or quality in another user's profile. For example, if a first user has an advertisable characteristic, seeking an experienced patent attorney in a certain geographical area, and a second user has posted its job description as a seasoned patent attorney in or near such geographical area, the self-initiated query would identify the two users as a match.

Optionally, the method 400 may also include a value calculation during the self-initiated query 408. In one embodiment, as soon as a user uploads entity-specific characteristics to the system 300, a value calculator may evaluate each of the entity-specific characteristics for similarities for commonly used terms. In such an embodiment, for example, if a user uploaded “patent litigator in New Jersey” as an entity-specific characteristic, a value calculator may find a high weighted value for such terms in association with “intellectual property,” “attorney”, “lawyer”, “east coast”, “Atlantic,” etc., by using a commercially available or system created/updatable thesaurus for such terms. A threshold may be set by an administrator, user/entity, or combinations thereof, for a determination of precision when utilizing a value calculation step. As understood by embodiments herein, using such a value calculator enables the system to link users where such linkage is desired by the users, but where each user's terminology is different.

At step 410, each of the plurality of user accounts identified during the self-initiated query are linked. For example, in one embodiment, each of the user accounts identified during the self-initiated query may be provided access to view one another's accounts. In another example, linking the accounts may comprise providing a hyperlink to associated accounts from each of the respective user's profiles.

At step 412, each of the linked user accounts from step 410 are notified of the identification of linked accounts. In one embodiment, the notification may comprise sending an email, an instant message, an administrator issued notification on a profile page, or the like, to each of the users linked. The notification may comprise of a simple or detailed list having any information suitable for the users to identify one another, including, for example, emails, user name, etc. The method ends at step 414.

In accordance with embodiments of the present invention, the method of self-advertising 400 may optionally include the step of generating revenue. In one embodiment, revenue may be generated by charging a single fee to the first entity 380, the second entity 386, or both the first and second entities 380, 386, and any N entities 392. For example, a single fee charged may be a sign-up fee, a flat fee, or the like, during creation of the user account in the system 300. In accordance with another embodiment of the present invention, revenue may be generated by charging fees to at least one entity at predetermined times, e.g., subscription fees. In accordance with yet a further embodiment, revenue may be generated by charging the first, second or N entities, 380, 386 or 392, respectively, or any combination thereof, a fee that is associated with the quantity of data transferred in an interaction. For example, an entity may be charged such a fee on a per transaction basis, which may include a fee per e-mail, a fee per webpage/profile viewed, or the like.

In accordance with another embodiment of the present invention, the method of self-advertising 400 may also include a step of rating an entity. In accordance with the embodiment, rating an entity may be based on a subjective evaluation of the interaction between two or more of the aforementioned entities by one of the entities involved. For example, if an interaction is conducted between a first entity 380 and a second entity 386, the first entity 380 may give the second entity 386 a rating evaluation based on the performance of the second entity 386 during the interaction. In this accord, the evaluation of the first entity 380 may help other entities decide whether or not to interact with the second entity 386 evaluated. In some embodiments, the method 400 may also include creating a plurality of user accounts within a database on the server, and storing the plurality of user accounts in a memory associated with the database, each of the user accounts corresponding to a user, and having a plurality of uploadable features; receiving from each user at least one advertisable characteristic comprising one or more terms, the advertisable characteristic associated with each user's user account; initiating a query of the database when a new user account is created or when an advertisible characteristic is received or modified, the query completed by identifying each of the user accounts that contain a number of advertisible characteristics in common by comparing the one or more terms of each advertisable characteristic and using a thesaurus to match the one or more terms of each advertisable characteristic that have the same or a similar meaning; calculating the value of each match with a value calculator and comparing the value to a threshold; automatically forming a user network by automatically linking user accounts and allowing the associated users to view the uploadable features of the linked accounts when the value of a match between user accounts exceeds the threshold; and notifying each of the plurality of user accounts that are linked to at least one user account when a link occurs, and/or the like.

While the foregoing is directed to embodiments of the present invention, other and further embodiments of the invention may be devised without departing from the basic scope thereof. It is understood that various embodiments described herein may be utilized in combination with any other embodiment described, without departing from the scope contained herein.

1. A method comprising:
creating a plurality of user accounts on a server, each of the plurality of user accounts corresponding to an entity of a plurality of entities;
storing the plurality of user accounts in a memory associated with the server;
wherein, if access is permitted, the plurality of user accounts are accessible remotely through a global computer network;
wherein each of the plurality of user accounts is associated with an entity profile of a plurality of entity profiles which are located on the server;
wherein each entity profile of the plurality of entity profiles includes characteristics specific to the corresponding user account of the plurality of user accounts and the corresponding entity of the plurality of entities;
and further comprising initiating a query specifying a first characteristic;
in response to the query specifying the first characteristic, identifying user accounts whose corresponding entity profile includes the first characteristic, wherein there are at least two user accounts whose corresponding entity profile includes the first characteristic; and
after identifying user accounts whose corresponding entity profile includes the first characteristic, automatically linking the user accounts whose corresponding entity profile includes the first characteristic.

2. The method of claim 1 wherein
the user accounts whose corresponding entity profile includes the first characteristic are automatically linked by providing a hyperlink to each of the user accounts whose corresponding entity profile includes the first characteristic from each of the entity profiles of the plurality of entity profiles of the other user accounts whose corresponding entity profile includes the first characteristic.

3. The method of claim 1 wherein
the user accounts whose corresponding entity profile includes the first characteristic are automatically linked by allowing each of the user accounts whose corresponding entity profile includes the first characteristic to view each of the other user accounts of the user accounts whose corresponding entity profile includes the first characteristic.

4. The method of claim 1 wherein
the user accounts whose corresponding entity profile includes the first characteristic are provided with a notification including a list which identifies a plurality of users corresponding to the user accounts whose corresponding entity profile includes the first characteristic.

5. The method of claim 4 wherein
the notification is an email.

6. The method of claim 1 wherein
one or more seeking user accounts of the user accounts whose corresponding entity profile includes the first characteristic indicate the first characteristic as something that one or more users corresponding to the one or more seeking user accounts are trying to obtain; and
one or more providing user accounts of the user accounts whose corresponding entity profile includes the first characteristic indicate the first characteristic as something that one or more users corresponding to the one or more providing user accounts are trying to provide.

7. The method of claim 6 wherein
the first characteristic is employment.

8. The method of claim 7 wherein
the first characteristic is a product.

9. The method of claim 6 wherein
the first characteristic is a service.

10. The method of claim 1 wherein
the user accounts whose corresponding entity profile includes the first characteristic, obtained the first characteristic through a user uploading the first characteristic.

11. A method comprising
creating a plurality of user accounts on a server, each of the plurality of user accounts corresponding to an entity of a plurality of entities;
storing the plurality of user accounts in a memory associated with the server;
wherein, if access is permitted, the plurality of user accounts are accessible remotely through a global computer network;
wherein each of the plurality of user accounts is associated with an entity profile of a plurality of entity profiles which are located on the server;
wherein each entity profile of the plurality of entity profiles includes characteristics specific to the corresponding user account of the plurality of user accounts and the corresponding entity of the plurality of entities;
and further comprising having a first user corresponding to a first user account of the plurality of user accounts enter a first searchable post;
linking the first user account with one or more of the other user accounts of the plurality of user accounts based on the first searchable post;
having the first user edit the first searchable post prior to deleting the first searchable post; and
updating the linking of the first user account with one or more of the other user accounts of the plurality of user accounts based on the edit of the first searchable post.

12. The method of claim 11 wherein
the first user account is linked with one or more of the other user accounts of the plurality of user accounts through an entity profile of the first user account and one or more entity profiles corresponding to one or more of the other user accounts of the plurality of user accounts.

13. The method of claim 11 wherein
the step of updating the linking of the first user account with one or more of the other user accounts of the plurality of user accounts based on the edit of the first searchable post updated a social network of linked users substantially in real time.
